(19) United States
(12) Patent Application Publication
(10) Pub. No.: US 2015/0084536 A1
(43) Pub. Date: Mar. 26, 2015

(54) Electronic Flash Device

(71) Applicant: Nissin Industries Ltd.

(72) Inventor: Tak Wah SHUM, North Point (CN)

(73) Assignee: Nissin Industries Ltd.

(21) Appl. No.: 14/036,143

(22) Filed: Sep. 25, 2013

(51) Int. Cl. H05B 41/36; H05B 41/30

(52) U.S. Cl. CPC H05B 41/36; H05B 41/30
USPC 315/240

(57) ABSTRACT

In an electronic flash device using a discharge flash tube (10) including a pair of discharge electrodes (14, 16) and a trigger electrode (18), an improvement is made to eliminate failures to emit flash light following a consecutive emitting of weak flash lights which is known to occur particularly when barium is used as the material for electron emission in the cathode (16) of the flash tube. A timing of applying the trigger voltage to the trigger electrode is delayed in relation to a timing of applying the discharge voltage to the discharge electrodes.

### TECHNICAL FIELD

The present invention relates to an electronic flash device including a trigger circuit and a booster circuit, and in particular to an electronic flash device which can produce flash lights without fail.

A conventional electronic flash device normally includes a discharge flash tube including a pair of discharge electrodes and a trigger electrode, a high voltage power source for generating a high voltage power, a main capacitor for storing the high voltage power generated by the high voltage power source, a booster circuit including booster capacitors for raising the voltage supplied by the high voltage power source to be applied to the discharge electrodes, a trigger circuit for generating a trigger voltage to be applied to the trigger electrode and a control circuit for coordinating the operation of the various components of the electronic flash device. See JP09-115681, for instance.

For some applications such as professional applications where consecutive lighting of the flash tube over a prolonged period of time is required, the flash tube is required to be durable against thermal stresses. For instance, the casing for the flash tube is made of quartz glass, and the electron emission material for the cathode of the flash tube is based on barium, instead of more conventional cesium.

The use of barium for the cathode material of the flash tube improves the performance of the flash tube under a high load operation, but it was found by the inventors that failures of light emission could occur if a weak flashing at a guide number of 1 to 2 is repeated. According to the experiments conducted by the inventors, it was further discovered that the severity of the failures of light emission worsens as the duration of the consecutive weak flashings increases. Such failures of light emission are desired to be eliminated.

According to the study conducted by the inventors, it was discovered that the severity of the failures of light emission can be reduced by suitably adjusting the timing of the operations of the booster circuit and the trigger circuit.

### SUMMARY OF THE INVENTION

### Task to Be Accomplished by the Invention

In view of such problems of the prior art, and the discoveries made by the inventors, a primary object of the present invention is to provide an improved electronic flash device which can effectively prevent failures to emit flash light.

A second object of the present invention is to provide an improved electronic flash device which can be made more reliable as compared to the conventional flash device by making only small modification.

### Means to Accomplish the Task

According to the present invention, such objects can be accomplished by providing an electronic flash device, comprising: a flash tube including a pair of discharge electrodes and a trigger electrode; a DC high voltage power source for generating a high voltage electric power; a main capacitor for storing high voltage electric charge supplied by the DC high voltage power source; a booster circuit for producing a discharge voltage to be applied to the discharge electrodes by increasing a voltage of the electric charge stored in the main capacitor; a trigger circuit for generating a trigger voltage to be applied to the trigger electrode; and a control unit for applying the discharge voltage and the trigger voltage to the discharge electrodes and the trigger electrode, respectively, in response to a shutter synchronization signal supplied from an external source; wherein the control unit is configured to delay a timing of applying the trigger voltage to the trigger electrode in relation to a timing of applying the discharge voltage to the discharge electrodes.

Because the discharge voltage is applied to the discharge electrodes before the trigger voltage is applied to the trigger voltage, the gas in the flash tube is ionized to a certain extent before the trigger voltage is applied to the flash tube. Therefore, the triggering of the flash tube is performed in a favorable condition so that the flash light is produced in a stable manner, particularly even when the weak flash light emission is repeated for a prolonged period of time.

It was found that the best results can be obtained when the timing for applying the trigger voltage to the trigger electrode is delayed by a time interval of 3 to 5 microseconds to the timing of applying the discharge voltage to the discharge electrodes.

Preferably, the booster circuit is provided with a first switching device for selectively applying the discharge voltage to the discharge electrodes, and the trigger circuit is provided with a second switching device, separately from the first switching device, for selectively applying the trigger voltage to the trigger electrode so that the delaying of the application of the trigger voltage in relation to the application of the discharge voltage can be achieved in a both simple and reliable manner.

### BRIEF DESCRIPTION OF THE DRAWINGS

Now the present invention is described in the following with reference to the appended drawings, in which:

FIG. 1 is an electric circuit diagram of an electronic flash device according to the present invention; and

FIG. 2 is a time chart showing the mode of operation of a control apparatus for the electronic flash device.

### DETAILED DESCRIPTION OF THE PREFERRED EMBODIMENT(S)

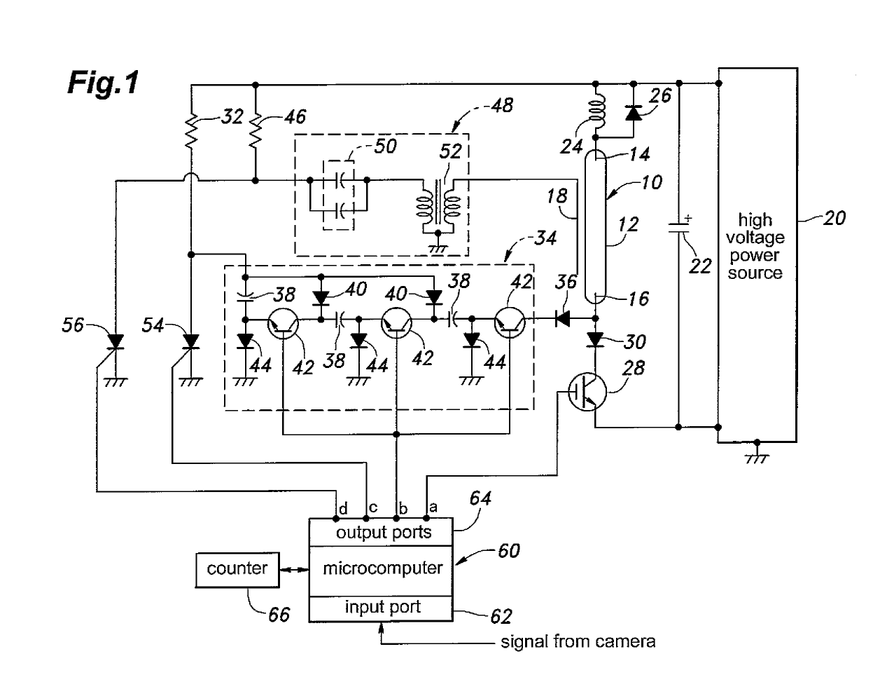

Referring to FIG. 1, the electronic flash device comprises a xenon discharge flash tube 10 which includes an elongated glass tube 12, a pair of discharge electrodes (anode and cathode) 14 and 16 provided on either axial end of the elongated glass tube 12 and a trigger electrode 18 provided on the outside of an intermediate part of the glass tube 12. In order for the xenon discharge flash tube 10 to withstand the thermal stress caused by the repeated lighting of the xenon discharge flash tube 10 over a prolonged period of time, the glass tube 12 is preferably made of quartz glass, and barium is used for the electron emission material of the cathode 16 of the discharge electrodes.

The electronic flash device further comprises a high voltage power source 20 which includes a DC power source typically consisting of a battery and a voltage booster circuit typically including a transformer and a DC-DC converter for producing a voltage of 300 to 350 volts.

The output end of the high voltage power source 20 is connected to a main capacitor 22 which is provided with a large capacity for storing the high voltage electric charges supplied by the high voltage power source 20.

The positive end of the main capacitor 22 is connected to the anode 14 of the xenon discharge flash tube 10 via a parallel circuit of a choke coil 24 and a diode 26. The negative end of the main capacitor 22 is connected to the cathode 16 of the xenon discharge flash tube 10 via a serial circuit of an IGBT (Insulated Gate Bipolar Transistor) 28 serving as a light intensity adjusting switching device and a diode 30. The main capacitor 22 applies a discharge voltage (which was originally supplied from the high voltage power source 20) to the anode 14 and the cathode 16 of the xenon discharge flash tube 10 in response to the turning on of the IGBT 28. Therefore, by adjusting the time duration of applying the discharge voltage to the xenon discharge flash tube 10 via the switching of the IGBT 28 in an appropriate manner, the amount of flash light emitted from the discharge flash tube 10 can be adjusted in an appropriate manner.

The output end of the high voltage power source 20 is connected to an input end of a booster circuit 34 via a resistor 32. The booster circuit 34 includes a plurality (three, in the illustrated embodiment) of booster capacitors 38 and a same number of switching transistors 42 which are connected in series in an alternating manner from the input end to the output end of the booster circuit 34. A charging diode 40 is provided in a path from the input end of the booster circuit 34 to the node between the first switching transistor 42 and the second booster capacitor 38. Another charging diode 40 is provided in a path from the input end of the booster circuit 34 to the node between second switching transistor 42 and the third booster capacitor 38. The node between each booster capacitor 38 and (the emitter of) the succeeding switching transistor 42 is grounded by a diode 44. The output end (the collector) of the third switching transistor 42 is connected to the anode 16 of the xenon discharge flash tube 10 via a diode 36. If the number of the booster capacitors 38 is n, the booster circuit 34 is able to increase the output voltage of the high voltage power source 20 by the factor of (n+1). In the illustrated embodiment, as there are three booster capacitors 38, a voltage four times the output voltage of the high voltage power source 20 (which may be in the order of 1,200 to 1,400 volts) can be obtained.

A switching device 54 typically consisting of a thyristor is connected between the input end of the booster circuit 34 and the ground.

The output end of the high voltage power source 20 is further connected to a trigger circuit 48 via a resistor 46. The trigger circuit 48 includes a plurality (two, in the illustrated embodiment) of trigger capacitors 50 connected in parallel to one another and a trigger transformer 52 connected in series to the parallel connection of the trigger capacitors 50. The output end of the trigger circuit 48 or the trigger transformer 52 is connected to the trigger electrode 18 of the xenon discharge flash tube 10.

A switching device 56 typically consisting of a thyristor is connected between the input end of the trigger circuit 48 and the ground. Thus, the switching device 56 for the trigger circuit 48 is provided separately from the switching device 54 for the booster circuit 34.

The electronic flash device further comprises a control unit 60 including a microcomputer, an input port 62 for receiving a signal from a camera, four output ports a-d including port a connected to the gate of the IGBT 28, port b connected to the gates (bases) of each switching transistor 42 of the booster circuit 34, port c connected to the gate of the switching device 54 for the booster circuit 34 and port d connected to the gate of the switching device 56 for the trigger circuit 48.

The signal from a camera supplied to the input port 62 may consist of any signal from the camera for determining the timing of lighting the flash tube 10, and may consist of a signal of a shutter button of the camera, a TTL (through the lens) signal, and/or a signal produced by the operation of the shutter of the camera. Upon receiving the signal from the camera, the microcomputer 60 produces output signals for output ports a to d according to a prescribed time sequence measured by a counter 66 provided in association with the microcomputer 60.

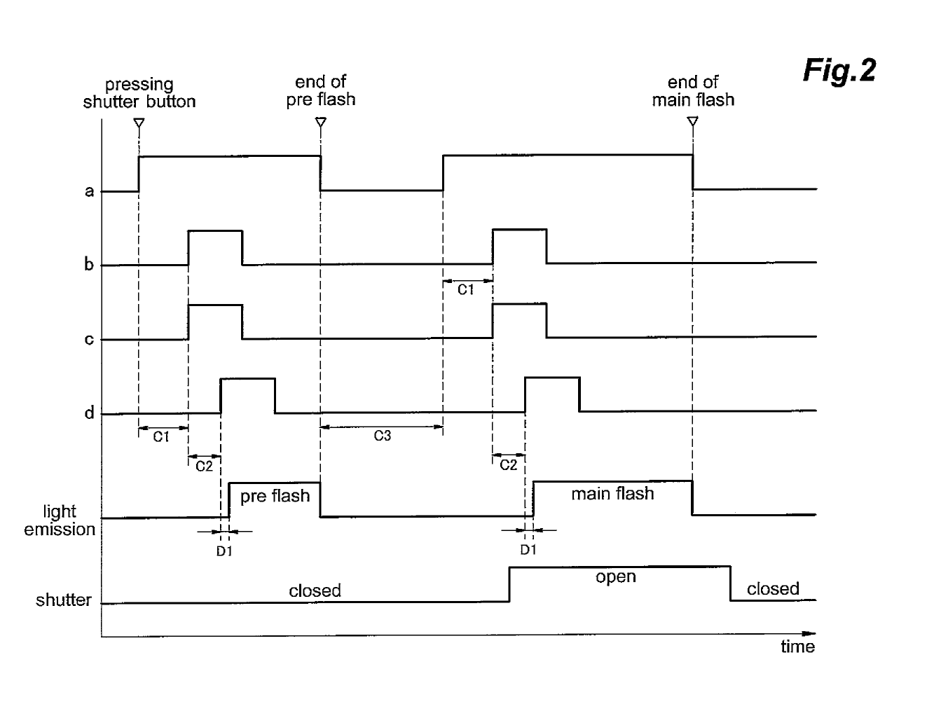

The timing of the output signals produced from the output ports a to d or the signals a to d is described in the following with reference to the time chart shown in FIG. 2. In this example, when the shutter button is pressed, the flash tube is lighted for a short duration of time (pre flash) before the shutter is opened, and following the opening of the shutter, the flash light is lighted for a required duration of time (main flash) for illuminating the object. The pre flash is used for various purposes such as preventing the red-eye, measuring the required amount of flash light and allowing a focal adjustment to be made when no other light is available for the focal adjustment.

Upon receiving a signal indicating the pressing of the shutter button is received from the input port 62, the microcomputer 60 turns signal a to a high level, thereby turning on the IGBT 28. As a result, the voltage of the main capacitor 22 is applied across the anode 14 and cathode 16 of the discharge electrodes of the xenon discharge flash tube 10.

The counter 66 starts counting the timing clock pulses upon receiving the shutter signal, and upon reaching a count number C1, turns signal b to a high level, thereby turning on the three switching transistors 42 and connecting the booster capacitors 38 all in series. At the same time, signal c is turned to a high level, and this causes the discharge voltage to be boosted by the booster circuit 34 and applied across the anode 14 and cathode 16 of the discharge electrodes of the xenon discharge flash tube 10.

By applying the boosted voltage across the anode 14 and cathode 16 of the discharge electrodes of the xenon discharge flash tube 10, the ionization of the xenon gas contained in the glass tube 12 is promoted, and the higher the boosted discharge voltage is, the more vigorously this ionization is promoted. The count number C1 may be determined depending on the variations in the properties of the IGBT 28, and is not essential for the operation of the electronic flash device.

The counter 66 is reset once the count number C1 is reached, and starts counting the timing clock pulses anew when signal c has turned to the high level.

Upon reaching the count number C2, the microcomputer 60 turns signal d to a high level, thereby causing the trigger voltage generated by the trigger circuit 48 to be applied to the trigger electrode 18. The count number C2 corresponds to the time interval between the application of the discharge voltage and the application of the trigger voltage to the trigger voltage, and this count number C2 preferably corresponds to a time duration in the range of 3 to 5 microseconds.

The xenon discharge flash tube 10 emits flash light with an extremely small time delay D1 from the time point of applying the trigger voltage. Meanwhile, the signals b, c and d are each turned off after a few microseconds from the time of turning on.

Once the time period designated for the pre flash has elapsed, the signal a is turned off so that the IGBT 28 is turned off. This completes the pre flash process.

Upon completion of the pre flash, the counter 66 is reset, and upon counting a count number C3, signal a is turned to a high level. As a result, the voltage of the main capacitor 22 is applied across the anode 14 and cathode 16 of the discharge electrodes of the xenon discharge flash tube 10. Thereafter, the main flash is produced in a similar fashion as the pre flash. However, the main flash is maintained until the amount of light received by the camera has reached a prescribed level.

In either case, or be it a pre flash or a main flash, because the application of the trigger voltage to the trigger electrode is slightly delayed to the application of the boosted discharge voltage to the discharge electrodes of the flash tube, the gas surrounding the discharge electrodes is favorably ionized before the trigger voltage is applied to the trigger electrode so that the subsequent application of the trigger voltage to the trigger electrode can ensure the emission of flash light without fail.

Therefore, according to this arrangement, even when weak flash light is successively emitted, the ionized state of the gas within the glass tube is favorably maintained, and the failures to emit flash light are effectively prevented.

The present invention was described in terms of a specific embodiment, but the present invention is not limited by the illustrated embodiments, and can be changed in various parts thereof. The contents of the prior art references mentioned in this application are incorporated in this application by reference.

1. An electronic flash device, comprising:
a flash tube including a pair of discharge electrodes and a trigger electrode;
a DC high voltage power source for generating a high voltage electric power;
a main capacitor for storing high voltage electric charge supplied by the DC high voltage power source;
a booster circuit for producing a discharge voltage to be applied to the discharge electrodes by increasing a voltage of the electric charge stored in the main capacitor;
a trigger circuit for generating a trigger voltage to be applied to the trigger electrode; and
a control unit for applying the discharge voltage and the trigger voltage to the discharge electrodes and the trigger electrode, respectively, in response to a shutter synchronization signal supplied from an external source;
wherein the control unit is configured to delay a timing of applying the trigger voltage to the trigger electrode in relation to a timing of applying the discharge voltage to the discharge electrodes.

2. The electronic flash device according to claim 1, wherein the booster circuit is provided with a first switching device for selectively applying the discharge voltage to the discharge electrodes, and the trigger circuit is provided with a second switching device, separately from the first switching device, for selectively applying the trigger voltage to the trigger electrode.

3. The electronic flash device according to claim 1, wherein the timing for applying the trigger voltage to the trigger electrode is delayed by a time interval of 3 to 5 microseconds to the timing of applying the discharge voltage to the discharge electrodes.
